(19) United States
(12) Patent Application Publication
(10) Pub. No.: US 2016/0352635 A1
(43) Pub. Date: Dec. 1, 2016

(54) COMMUNICATION ROUTE CONTROL DEVICE, COMMUNICATION ROUTE CONTROL SYSTEM, STORAGE MEDIUM STORING COMMUNICATION ROUTE CONTROL PROGRAM, AND COMMUNICATION ROUTE CONTROL METHOD

(71) Applicant: NEC Corporation, Minato-ku. Tokyo (JP)

(72) Inventor: Daisuke YOSHIZAKI, Tokyo (JP)

(73) Assignee: NEC Corporation, Minato-ku, Tokyo (JP)

(21) Appl. No.: 15/117,336

(22) PCT Filed: Feb. 26, 2015
(86) PCT No.: PCT/JP2015/000977

§ 371 Date: Aug. 8, 2016

(30) Foreign Application Priority Data
Mar. 10, 2014 (JP) 2014-046448

(51) Int. Cl. H04L 12/721; H04L 29/12; H04L 29/06

(52) U.S. Cl. CPC H04L 45/70; H04L 65/1006; H04L 61/103

(57) ABSTRACT

[Problem] To provide a communication route control device, a communication route control system, a storage medium storing a communication route control program, and a communication route control method, with which the operating efficiency of a communication network can be increased and a decrease in communication quality can be satisfactorily prevented. [Solution] A communication means (11) is connected to each of multiple information transmission devices, including a first information transmission device connected to a first session initiation protocol (SIP) server and a second information transmission device connected to a second SIP server, with communication paths being set between the information transmission devices. On the basis of available capacity information, which indicates the available capacity of the communication paths between the information transmission devices and is obtained from each information transmission device by the communication means (11), a control means (12) sets a new route so as to avoid the communication path having the least available capacity.

### TECHNICAL FIELD

The present invention relates to a communication route control device, a communication route control system, a storage medium storing a communication route control program, and a communication route control method for controlling a route for transmitting and receiving a speech packet.

### BACKGROUND ART

A Voice over Internet Protocol (VoIP) is provided as a call service by an Internet Protocol (IP) technique using a communication system. Further, there is a communication system in which a Session Initiation Protocol (SIP) is employed as a call control protocol.

FIG. 7 is a block diagram illustrating an example of a communication system in which an SIP is employed as a call control protocol. The communication system illustrated in FIG. 7 includes switches 2a and 2b, routers 3a, 3b, and 3c, and SIP servers 4a and 4b. The switch 2a to be connected to IP phones la and lb is connected to the router 3a.

The router 3a is connected to the SIP server 4a and to the routers 3b and 3c, and transmits and receives a packet to and from the router 3b according to an instruction of the SIP server 4a. The switch 2b to be connected to IP phones 1c and 1d is connected to the router 3b. The router 3b is connected to the SIP server 4b and to the routers 3a and 3c, and transmits and receives a packet to and from the router 3a according to an instruction of the SIP server 4b.

For instance, when the IP phone 1a sends a call request to the IP phone 1d to perform a call, first of all, a call control packet for establishing a call on the basis of an SIP is transmitted from the IP phone 1a to the IP phone 1d via the SIP servers 4a and 4b. Specifically, a call control packet is transmitted from the IP phone 1a to the IP phone 1d via the switch 2a, the router 3a, the SIP server 4a, the router 3a, the router 3b, the SIP server 4b, the router 3b, and the switch 2b.

Thereafter, when the call is established, a speech packet is transmitted and received between the IP phones 1a and 1d via the switch 2a, the router 3a, the router 3b, and the switch 2b.

PTL 1 describes a system, in which a priority is set in advance for each of communication terminals using a VoIP.

PTL 2 describes a method for deciding a route for transmitting and receiving a packet on the basis of a traffic amount and a band width between nodes of a communication network.

### CITATION LIST

### Patent Literature

[PTL 1] Japanese Laid-open Patent Publication No. 2008-92257

[PTL 2] Japanese Laid-open Patent Publication No. 2011-97656

### SUMMARY OF INVENTION

### Technical Problem

In the communication system illustrated in FIG. 7, however, when the traffic amount between the routers 3a and 3b increases, and congestion occurs, communication of a speech packet being transmitted and received during a call may stagnate, and speech quality may deteriorate. This may adversely affect the call. The reason for this is described as follows. A speech packet to be transmitted and received between the IP phones (e.g. IP phones connected by a same Local Area Network (LAN), or IP phones using a same SIP server) 1a and 1b of one of the segments, and a speech packet to be transmitted and received between the IP phones 1c and 1d of another one of the segments pass a same route. Therefore, the speech packet to be transmitted and received between the IP phones 1a and 1b, and the speech packet to be transmitted and received between the IP phones 1c and d pass the same routers 3a, 3b, and the like. This may cause an excessive load on the routers 3a and 3b. The reason why a speech packet to be transmitted and received between the IP phones 1a and 1b, and a speech packet to be transmitted and received between the IP phones 1c and 1d pass the same routers 3a and 3b or the like is because routing tables of the routers 3a and 3b are set such that the routers 3a and 3b are adjacent to each other on a communication circuit. Therefore, transmitting and receiving a speech packet via the router 3c is not performed.

The system described in PTL 1 is configured to discard a packet whose priority is low when a communication network is congested. Then, a speech packet being transmitted and received during a call may be discarded, or speech quality may deteriorate. This may also adversely affect the call.

Further, in the method described in PTL 2, IP phones also employ a symmetrical routing for reducing the amount of management data, and packets are transmitted and received on a same route (see paragraphs [0030 ]and [0069] of PTL 2). In an SIP, whereas a call control packet is transmitted and received via the SIP servers 4a and 4b, a speech packet is transmitted and received without via the SIP servers 4a and 4b. When a symmetrical routing is applied to the call control packet and to the speech packet, a route passing the SIP servers 4a and 4b is also selected in transmitting and receiving the speech packet. Then, this may increase the traffic amount of a communication network, and may cause congestion in the communication network.

In view of the above, an object of the present invention is to provide a communication route control device, a communication route control system, a storage medium storing a communication route control program, and a communication route control method that enable to advantageously prevent lowering of speech quality by enhancing the operating efficiency of a communication network.

### Solution to Problem

A communication route control device, according to the present invention, comprises:

a communication means connected to each of a plurality of information transmission devices including a first information transmission device connected to a first SIP server, and a second information transmission device connected to a second SIP server, with communication paths set between the information transmission devices; and

a control means which sets a new route while avoiding a communication path whose vacant capacity is smallest on the basis of vacant capacity information indicating vacant capacities of the communication paths between the information transmission devices, the vacant capacity information being acquired from each of the information transmission devices by the communication means.

A communication route control system comprises:

any one of aspects of the communication route control device;

the first SIP server;

the second SIP server; and

the plurality of the information transmission devices.

A storage medium storing a communication route control program, according to the present invention, which causes a computer to execute:

a communication process of communicating with each of a plurality of information transmission devices including a first information transmission device connected to a first SIP server, and a second information transmission device connected to a second SIP server, with communication paths set between the information transmission devices; and

a control process of setting a new route while avoiding a communication path whose vacant capacity is smallest on the basis of vacant capacity information indicating vacant capacities of the communication paths between the information transmission devices, the vacant capacity information being acquired from each of the information transmission devices by the communication process.

A communication route control method, according to the present invention, comprises:

a communication step for communicating with each of a plurality of information transmission devices including a first information transmission device connected to a first SIP server, and a second information transmission device connected to a second SIP server, with communication paths set between the information transmission devices; and

a controlling step for setting a new route while avoiding a communication path whose vacant capacity is smallest on the basis of vacant capacity information indicating vacant capacities of the communication paths between the information transmission devices, the vacant capacity information being acquired from each of the information transmission devices.

### Advantageous Effects of Invention

According to the present invention, it is possible to enhance the operating efficiency of a communication network. Further, it is possible to advantageously prevent lowering of speech quality.

### BRIEF DESCRIPTION OF DRAWINGS

FIG. 1 is a block diagram illustrating an example of a communication network connected to a control server in a first exemplary embodiment of the present invention.

FIG. 2 is a block diagram illustrating a configuration example of the control server in the first exemplary embodiment of the present invention.

FIG. 3 is a sequence diagram illustrating an operation until a session is established between an IP phone and another IP phone in a communication network connected to the control server in the first exemplary embodiment of the present invention.

FIG. 4 is a flowchart illustrating an operation of changing a speech packet route by the control server in the first exemplary embodiment of the present invention.

FIG. 5 is a block diagram illustrating an example of a communication route control device in a second exemplary embodiment of the present invention.

FIG. 6 is a block diagram illustrating an example of a communication route control system in a third exemplary embodiment of the present invention.

FIG. 7 is a block diagram illustrating an example of a communication system in which an SIP is used as a call control protocol.

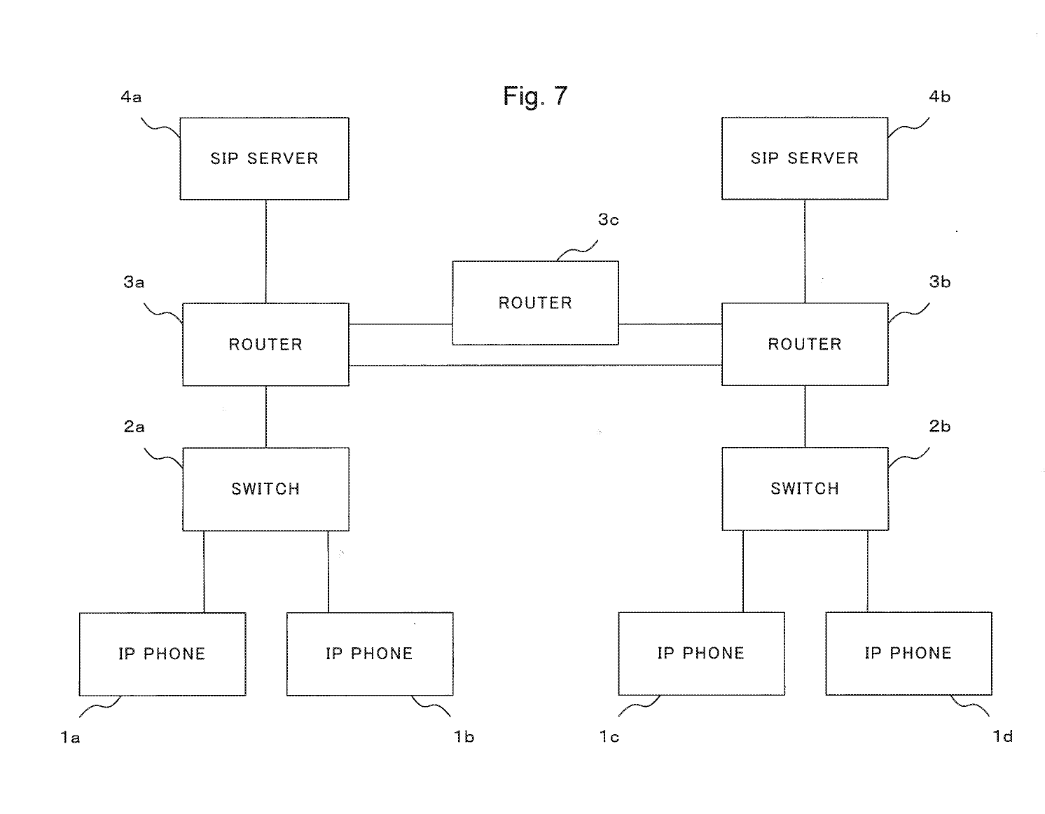

### DESCRIPTION OF EMBODIMENTS

### First Exemplary Embodiment

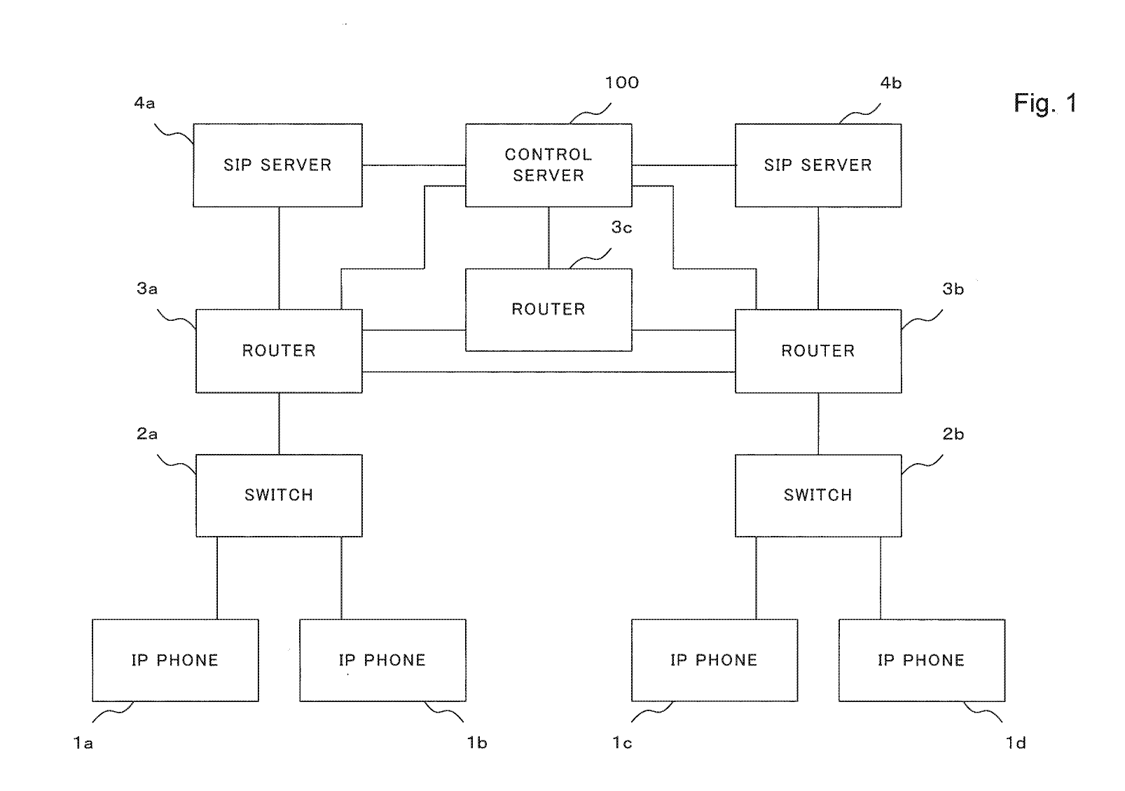

The first exemplary embodiment of the present invention is described referring to the drawings. FIG. 1 is a block diagram illustrating an example of a communication network connected to a control server (communication route control device) 100 in the first exemplary embodiment of the present invention. As illustrated in FIG. 1, the control server 100 in the first exemplary embodiment of the present invention is connected to each of routers 3a, 3b, and 3c, and SIP servers 4a and 4b.

The control server 100 controls transmission destinations of speech packets in the routers 3a, 3b, and 3c in cooperation with the SIP servers 4a and 4b. In other words, the control server 100 controls transmission routes of speech packets in cooperation with the SIP servers 4a and 4b. Note that speech packets and call control packets are also generically and simply referred to as packets.

Note that the control server 100 acquires in advance connection statuses between the routers 3a, 3b, and 3c, and the SIP servers 4a and 4b on the basis of an Address Resolution Protocol (ARP) or a Link Layer Discovery Protocol (LLDP). Then, the control server 100 causes a storage means (not illustrated) to store the acquired information in advance. Further, the control server 100 causes a storage means to store in advance information indicating each of the routes along which a packet may pass when a call using the SIP server 4a and the SIP server 4b is performed. Furthermore, the control server 100 causes a storage means to store in advance information indicating a router which relays a packet for each of the routes along which the packet may pass, and information indicating an allowable communication amount of a communication path between the routers on each route.

The switch 2a to be connected to IP phones la and lb is connected to the router 3a. The router 3a is connected to the control server 100, the SIP server 4a, and the routers 3b and 3c. Then, the router 3a decides a transmission destination of a received packet depending on whether the received packet is a speech packet or a call control packet and according to the transmission destination, in accordance with at least one of controls by the control server 100 and the SIP server 4a. Specifically, the router 3a transmits a received packet to either one of the SIP server 4a, the routers 3b and 3c, and the switch 2a.

The switch 2b to be connected to IP phones 1c and 1d is connected to the router 3b. The router 3b is connected to the control server 100, the SIP server 4b, and the routers 3a and 3c. Then, the router 3b decides a transmission destination of a received packet depending on whether the received packet is a speech packet or a call control packet and according to the transmission destination, in accordance with at least one of controls by the control server 100 and the SIP server 4b. Specifically, the router 3b transmits a received packet to either one of the SIP server 4b, the routers 3a and 3c, and the switch 2b.

The router 3c is connected to the routers 3a and 3b, transmits a speech packet received from the router 3a to the router 3b, and relays the transmission of a speech packet received from the router 3b to the router 3a.

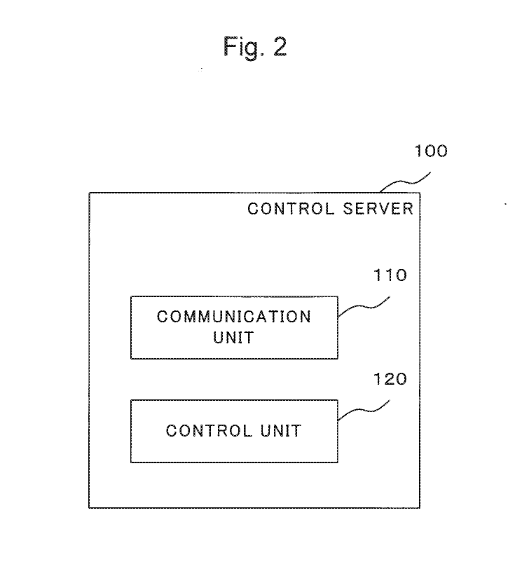

FIG. 2 is a block diagram illustrating a configuration example of the control server 100 in the first exemplary embodiment of the present invention. As illustrated in FIG. 2, the control server 100 in the first exemplary embodiment of the present invention includes a communication unit 110 and a control unit 120. The control unit 120 transmits and receives information to and from the SIP servers 4a and 4b, and the routers 3a, 3b, and 3c via the communication unit 110. Specifically, the communication unit 110 acquires information on the traffic amount from the routers 3a, 3b, and 3c in accordance with an instruction of the control unit 120, and instructs a transmission destination of a speech packet to the routers 3a, 3b, and 3c. Further, the communication unit 110 transmits and receives information to and from the SIP servers 4a and 4b in accordance with an instruction of the control unit 120.

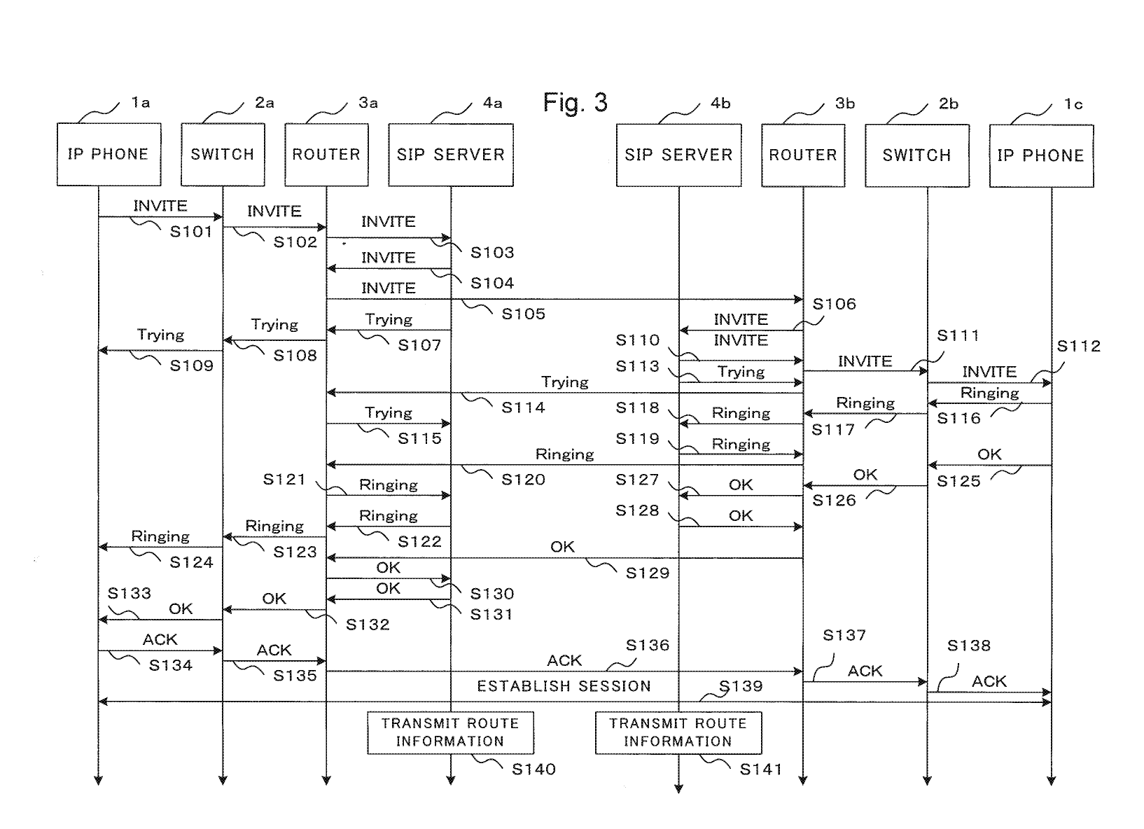

Next, an operation of a communication network connected to the control server 100 in the first exemplary embodiment of the present invention is described. First of all, an operation until a session is established between the IP phone 1a and the IP phone 1c after the IP phone 1a sends a call request to the IP phone 1c is described. FIG. 3 is a sequence diagram illustrating an operation until a session is established between the IP phone 1a and the IP phone 1c in a communication network connected to the control server 100 in the first exemplary embodiment of the present invention.

As illustrated in FIG. 3, first of all, when the phone number of the IP phone 1c is input as a phone number of a call destination, the IP phone 1a performs the following process. Specifically, the IP phone 1a transmits an INVITE message, which is a call control packet indicating that the IP phone 1a is calling the IP phone 1c, to the SIP server 4a, which is associated with the IP phone 1a (Step S101).

The INVITE message transmitted by the process of Step S101 is transmitted to the SIP server 4a via the switch 2a and the router 3a (Steps S102 and S103).

The SIP server 4a that receives the INVITE message transmitted by the process of Step S101 performs the following process. Specifically, the SIP server 4a transmits the INVITE message to the SIP server 4b, which is associated with the IP phone 1c, on the basis that the call destination is the IP phone 1c as indicated in the INVITE message (Step S104). The INVITE message transmitted by the process of Step S104 is transmitted to the SIP server 4b via the routers 3a and 3b (Steps S105 and S106).

Further, the SIP server 4a that transmits the INVITE message to the SIP server 4b in the process of Step S104 transmits a Trying message, which is a call control packet indicating that a call process is being executed, to the IP phone 1a (Step S107). The Trying message transmitted by the process of Step S107 is transmitted to the IP phone 1a via the router 3a and the switch 2a (Steps S108 and S109).

The SIP server 4b that receives the INVITE message transmitted by the process of Step S104 performs the following process. Specifically, the SIP server 4b transmits the INVITE message to the IP phone 1c on the basis that the call destination is the IP phone 1c as indicated in the INVITE message (Step S110). The INVITE message transmitted by the process of Step S110 is transmitted to the IP phone 1c via the router 3b and the switch 2b (Steps S111 and S112).

Further, the SIP server 4b that transmits the INVITE message to the IP phone 1c in the process of Step S110 transmits a Trying message, which is a call control packet indicating that a call process is being executed, to the SIP server 4a (Step S113). The Trying message transmitted by the process of Step S113 is transmitted to the SIP server 4a via the routers 3b and 3a (Steps S114 and S115).

The IP phone 1c that receives the INVITE message transmitted by the process of Step S110 performs a call operation such as outputting a ringtone. Then, the IP phone 1c transmits a Ringing message, which is a call control packet indicating that the IP phone 1c is being called, to the IP phone 1a on the basis that the call source of the received INVITE message is the IP phone 1a (Step S116). The Ringing message transmitted by the process of Step S116 is transmitted to the IP phone 1a via the switch 2b, the router 3b, the SIP server 4b, the router 3b, the router 3a, the SIP server 4a, the router 3a, and the switch 2a (Steps S117 to S124).

The IP phone 1a that receives the Ringing message transmitted by the process of Step S116 performs an incoming call waiting operation such as outputting a ringback tone.

Further, when a user performs a receiving operation with use of the IP phone 1c, the IP phone 1c transmits an OK message, which is a call control packet indicating that start of a call session is accepted, to the IP phone 1a (Step S125). The OK message transmitted by the process of Step S125 is transmitted to the IP phone 1a via the switch 2b, the router 3b, the SIP server 4b, the router 3b, the router 3a, the SIP server 4a, the router 3a, and the switch 2a (Steps S126 to S133).

The IP phone 1a that receives the OK message transmitted from the IP phone 1c by the process of Step S125 transmits an ACK response, which is a call control packet indicating that the OK message is received, to the IP phone 1c (Step S134). The ACK response transmitted by the process of Step S134 is transmitted to the IP phone 1c via the switch 2a, the router 3a, the router 3b, and the switch 2b (Steps S135 to S138).

By the processes of Steps S101 to S138, a speech packet route via the switch 2a, the router 3a, the router 3b, and the switch 2b is set between the IP phone 1a and the IP phone 1c, and a session is established (Step S139). Then, the SIP server 4a causes each of the storage means (not illustrated) to store the set speech packet route on the basis that the OK message transmitted by the process of Step S125 is received by the process of Step S130. Further, the SIP server 4b causes each of the storage means (not illustrated) to store the set speech packet route on the basis that the OK message transmitted by the process of Step S125 is received by the process of Step S127. Further, the SIP servers 4a and 4b transmit route information indicating the set speech packet routes to the control server 100, and notifies that a session is established (Steps S140 and S141).

Then, the SIP server 4a sets a routing table of the router 3a in such a manner that the router 3a transmits a packet transmitted to the IP phone 1c to the router 3b. Further, the SIP server 4a sets a routing table of the router 3a in such a manner that the router 3a transmits a packet transmitted to the IP phone 1a to the switch 2a.

The SIP server 4b sets a routing table of the router 3b in such a manner that the router 3b transmits a packet transmitted to the IP phone la to the router 3a. Further, the server 4b sets a routing table of the router 3b in such a manner that the router 3b transmits a packet transmitted to the IP phone 1c to the switch 2b.

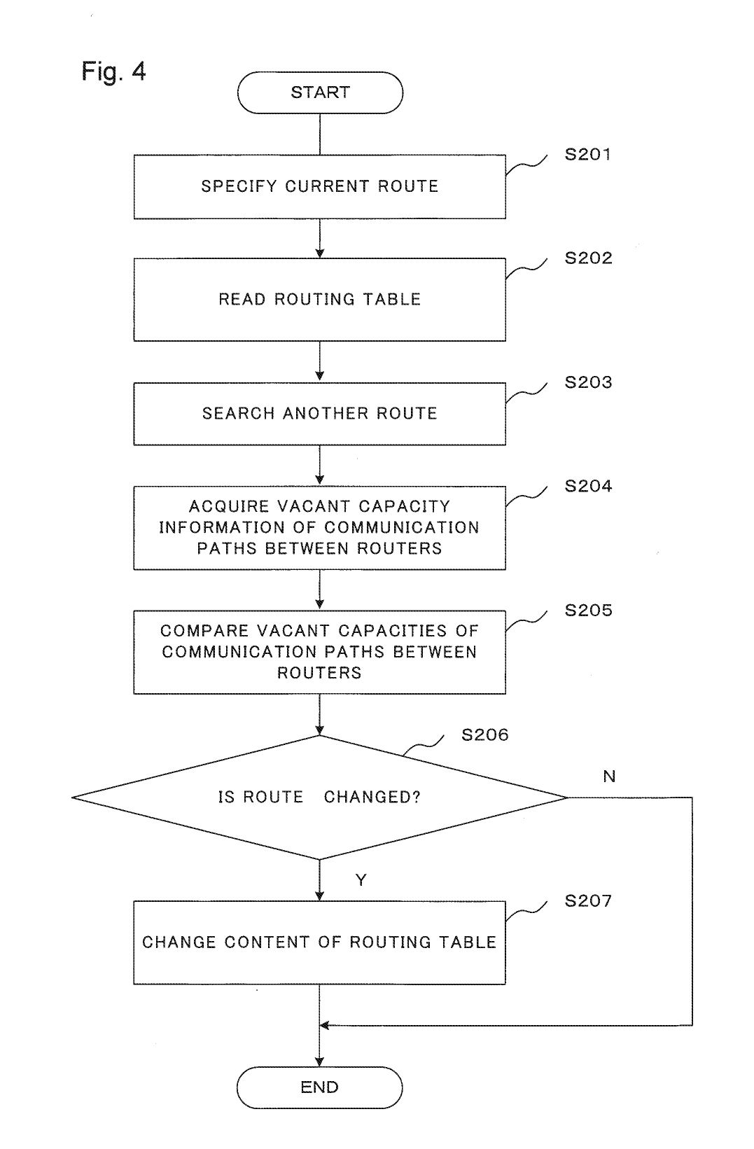

Next, an operation of changing a speech packet route which is initially set by the processes in the steps illustrated in FIG. 3, after the control server 100 in the first exemplary embodiment of the present invention performs the processes on the basis of a traffic amount between the routers 3a, 3b, and 3c, is described. In this example, an initially set route along which the router 3a and the router 3b transmit and receive a speech packet without via the router 3c is changed to a route along which the router 3a and the router 3b transmit and receive a speech packet via the router 3c. FIG. 4 is a flowchart illustrating an operation of changing a speech packet route by the control server 100 in the first exemplary embodiment of the present invention.

As illustrated in FIG. 4, first of all, the control server 100 performs the following process on the basis of route information received by the communication unit 110 from the SIP servers 4a and 4b by the processes of Steps S140 and S141. Specifically, the control unit 120 in the control server 100 specifies a speech packet route between the IP phones 1a and 1c (Step S201). In this example, the control unit 120 in the control server 100 specifies that the router 3a and the router 3b directly transmit and receive a speech packet.

Next, the communication unit 110 in the control server 100 reads a routing table from the routers 3a and 3b (Step S202). Then, the control unit 120 in the control server 100 searches another speech packet route between the IP phones 1a and 1c on the basis of the routing table read from the routers 3a and 3b by the communication unit 110 by the process of Step S202 (Step S203). In this example, it is assumed that the control unit 120 in the control server 100 finds a route for transmitting and receiving a speech packet between the router 3a and the router 3b via the router 3c by the search in the process of Step S203.

The communication unit 110 in the control server 100 acquires vacant capacity information indicating a vacant capacity of a communication path between the routers 3a and 3b, between the routers 3b and 3c, and between the routers 3c and 3a from each of the routers 3a, 3b, and 3c on the basis of a search result by the control unit 120 (Step S204). Specifically, for instance, the communication unit 110 in the control server 100 requests each of the routers 3a, 3b, and 3c to transmit vacant capacity information indicating vacant capacities of communication paths between the routers 3a and 3b, between the routers 3b and 3c, and between the routers 3c and 3a. Then, the communication unit 110 in the control server 100 receives the vacant capacity information transmitted by each of the routers 3a, 3b, and 3c in response to the request.

The control unit 120 in the control server 100 compares the vacant capacities of communication paths between the routers 3a and 3b, between the routers 3b and 3c, and between the routers 3c and 3a on the basis of the vacant capacity information acquired by the process of Step S204 (Step S205). Specifically, for instance, it is assumed that the vacant capacity of a communication path between the router 3a and the router 3b, which is indicated by vacant capacity information received from at least one of the router 3a and the router 3b is 10 Mbps (bits per second). Further, it is assumed that the vacant capacity of a communication path between the router 3a and the router 3c, which is received from at least one of the router 3a and the router 3c is 20 Mbps. Furthermore, it is assumed that the vacant capacity of a communication path between the router 3b and the router 3c, which is received from at least one of the router 3b and the router 3c is 30 Mbps.

Then, it is clear that the vacant capacity of a communication path between the router 3a and the router 3b via the router 3c is larger than the vacant capacity of an initially set communication path for directly connecting between the routers 3a and 3b. Accordingly, in this example, the control unit 120 in the control server 100 decides to change the speech packet route from the initially set route to the route via the router 3c (Y in Step S206). In other words, the control unit 120 in the control server 100 avoids a communication path whose vacant capacity is smallest (in this example, a communication path between the routers 3a and 3b), and changes the speech packet route to a new route. According to the aforementioned configuration, it is possible to advantageously prevent speech packet loss, and to advantageously prevent lowering of speech quality due to speech packet loss.

The control unit 120 in the control server 100 sets a routing table of the router 3a in such a manner that the router 3a transmits a packet transmitted to the IP phone 1c to the router 3c. Further, the control unit 120 in the control server 100 sets a routing table of the router 3b in such a manner that the router 3b transmits a packet transmitted to the IP phone 1a to the router 3c. Furthermore, the control unit 120 in the control server 100 sets a routing table of the router 3c in such a manner that the router 3c transmits a packet transmitted to the IP phone 1a to the router 3a, and transmits a packet transmitted to the IP phone 1c to the router 3b (Step S207).

When the vacant capacity of an initially set route is larger than the vacant capacity of a newly searched route (N in Step S206), the process is terminated without changing the route.

Note that when there is no vacant capacity in an initially set route, and a newly searched route does not have a vacant capacity capable of transmitting and receiving a speech packet, the control server 100 notifies an error to the SIP servers 4a and 4b. Then, the SIP servers 4a and 4b disconnect the call in response to a notification of an error from the control server 100.

The control server 100 executes each of the processes illustrated in FIG. 4 when receiving route information that is transmitted in response to receiving an OK message by the SIP servers 4a and 4b, and periodically executes each of the processes illustrated in FIG. 4. Note that the control server 100 may execute each of the processes illustrated in FIG. 4 at other timings. Specifically, for instance, the another timing is a time when a processing load of one of the routers 3a, 3b, and 3c excessively increases, or a time when transmitting and receiving a call control packet is started.

By causing the control server 100 to periodically execute each of the processes illustrated in FIG. 4, it is possible to flexibly change a speech packet route in response to a change in the communication amount in each of the routes.

According to the exemplary embodiment, the control server 100 uses a route whose vacant capacity is relatively large among a plurality of routes between the routers 3a and 3b for transmitting and receiving a speech packet. Accordingly, it is possible to increase the operating efficiency of a communication network. Further, it is possible to avoid use of a route whose vacant capacity is relatively small in transmitting and receiving a speech packet. This makes it possible to advantageously prevent lowering of speech quality due to speech packet loss.

### Second Exemplary Embodiment

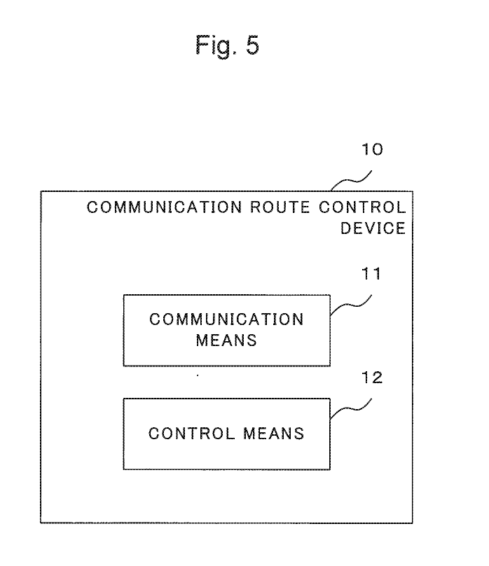

The second exemplary embodiment of the present invention is described referring to the drawing. FIG. 5 is a block diagram illustrating an example of a communication route control device 10 in the second exemplary embodiment of the present invention. As illustrated in FIG. 5, the communication route control device (corresponding to the control server 100 illustrated in FIG. 1) 10 in the second exemplary embodiment of the present invention includes a communication means (corresponding to the communication unit 110 illustrated in FIG. 2) 11, and a control means (corresponding to the control unit 120 illustrated in FIG. 2) 12.

The communication means 11 is connected to a first information transmission device connected to a first SIP server. Further, the communication means 11 is connected to a second information transmission device, which is connected to a second SIP server and to the first information transmission device for transmitting and receiving a speech packet to and from the first information transmission device. Further, the communication means 11 is connected to another information transmission device, which is connected to the first information transmission device and to the second information transmission device.

Note that the first SIP server corresponds to the SIP server 4a illustrated in FIG. 1. The first information transmission device corresponds to the router 3a illustrated in FIG. 1. The second SIP server corresponds to the SIP server 4b illustrated in FIG. 1. The second information transmission device corresponds to the router 3b illustrated in FIG. 1. The another information transmission device corresponds to the router 3c illustrated in FIG. 1.

The control means 12 sets a new route while avoiding a communication path whose vacant capacity is smallest on the basis of vacant capacity information indicating vacant capacities of communication paths between the information transmission devices, which is acquired by the communication means 11.

According to the exemplary embodiment, it is possible to enhance the operating efficiency of a communication network. Further, it is possible to advantageously prevent lowering of speech quality.

### Third Exemplary Embodiment

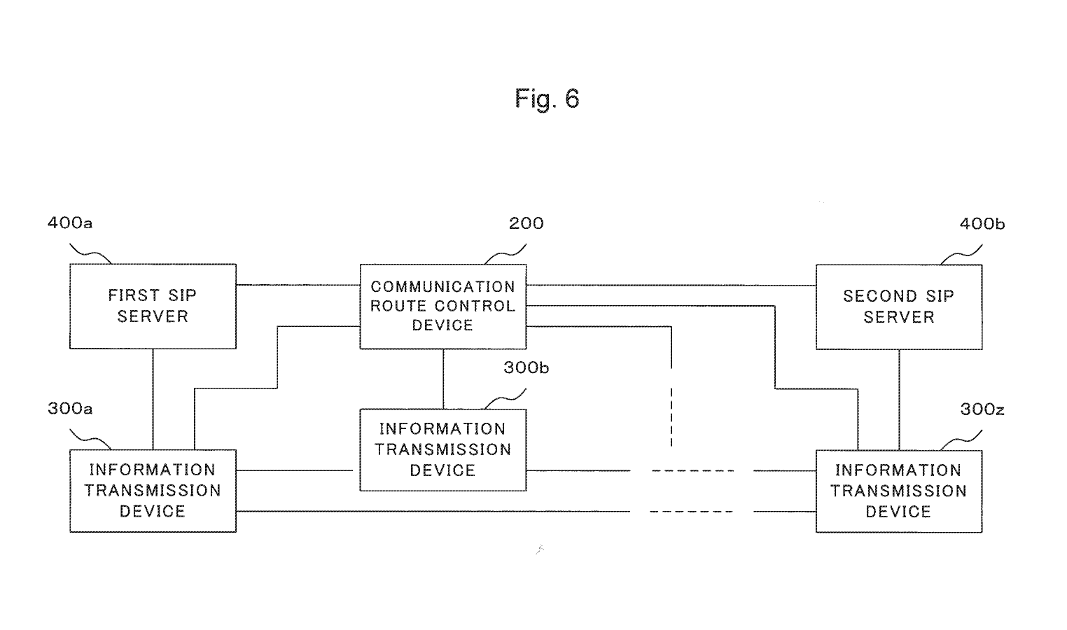

The third exemplary embodiment of the present invention is described referring to the drawing. FIG. 6 is a block diagram illustrating an example of a communication route control system in the third exemplary embodiment of the present invention. As illustrated in FIG. 6, the communication route control system in the third exemplary embodiment of the present invention includes a communication route control device 200, information transmission devices 300a, 300b, . . . , and 300z, a first SIP server 400a, and a second SIP server 400b.

The communication route control device 200 in the exemplary embodiment corresponds to the control server 100 in the first exemplary embodiment illustrated in FIG. 1, or to the communication route control device 10 in the second exemplary embodiment. The information transmission devices 300a, 300b, . . . , and 300z in the exemplary embodiment correspond to the routers 3a, 3b, and 3c illustrated in FIG. 1. The first SIP server 400a and the second SIP server 400b in the exemplary embodiment correspond to the first SIP server 4a and the second SIP server 4b illustrated in FIG. 1, respectively.

In the exemplary embodiment, the information transmission device 300a is connected to the first SIP server, and the information transmission device 300z is connected to the second SIP server. Further, a communication path is set between the information transmission devices 300a, 300b, . . . , and 300z.

According to the exemplary embodiment, it is possible to enhance the operating efficiency of a communication network. Further, it is possible to advantageously prevent lowering of speech quality.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2014-046448, filed on Mar. 10, 2014, the disclosure of which is incorporated herein in its entirety by reference.

### REFERENCE SIGNS LIST

1a, 1b, 1c, 1d IP phone
2a, 2b Switch
3a, 3b, 3c Router
4a, 4b SIP server
10, 200 Communication route control device
11 Communication means
12 Control means
100 Control server
110 Communication unit
120 Control unit
300a, 300b, 300z Information transmission device
400a First SIP server
400b Second SIP server

What is claimed is:

1. A communication route control device comprising:
a communication unit connected to each of a plurality of information transmission devices including a first information transmission device connected to a first SIP server, and a second information transmission device connected to a second SIP server, with communication paths set between the information transmission devices; and
a control unit which sets a new route while avoiding a communication path whose vacant capacity is smallest on the basis of vacant capacity information indicating vacant capacities of the communication paths between the information transmission devices, the vacant capacity information being acquired from each of the information transmission devices by the communication unit.

2. The communication route control device according to claim 1, wherein
when the new route is set, the control unit sets a routing table of each of the information transmission devices in association with the route according to the route.

3. The communication route control device according to claim 1, wherein
the communication unit is connected to the first SIP server and to the second SIP server, and acquires route information indicating a speech packet route from the first SIP server and from the second SIP server.

4. The communication route control device according to claims 1, wherein
the control unit sets a route in such a manner that the route passes a communication path whose vacant capacity is largest among the communication paths between the information transmission devices.

5. The communication route control device according to claims 1, wherein
the communication unit periodically acquires vacant capacity information from each of the information transmission devices, and
the control unit judges whether or not a new route is to be set on the basis of the vacant capacity information acquired by the communication unit.

6. A communication route control system comprising:
the communication route control device of claim 1;
the first SIP server;
the second SIP server; and
the plurality of the information transmission devices.

7. A storage medium storing a communication route control program which causes a computer to execute:
a communication process of communicating with each of a plurality of information transmission devices including a first information transmission device connected to a first SIP server, and a second information transmission device connected to a second SIP server, with communication paths set between the information transmission devices; and
a control process of setting a new route while avoiding a communication path whose vacant capacity is the smallest on the basis of vacant capacity information indicating vacant capacities of the communication paths between the information transmission devices, the vacant capacity information being acquired from each of the information transmission devices by the communication process.

8. A communication route control method comprising:
communicating with each of a plurality of information transmission devices including a first information transmission device connected to a first SIP server, and a second information transmission device connected to a second SIP server, with communication paths set between the information transmission devices; and
setting a new route while avoiding a communication path whose vacant capacity is smallest on the basis of vacant capacity information indicating vacant capacities of the communication paths between the information transmission devices, the vacant capacity information being acquired from each of the information transmission devices.
